(19) United States
(12) Patent Application Publication
(10) Pub. No.: US 2004/0128177 A1
(43) Pub. Date: Jul. 1, 2004

(54) System and method for balancing manufacturing orders

(76) Inventor: Hung-Shan Wei, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/648,598

(22) Filed: Aug. 25, 2003

(30) Foreign Application Priority Data
Dec. 27, 2002 (TW) 91137605

(51) Int. Cl. G06F 19/00

(52) U.S. Cl. 705/8; 700/99

(57) ABSTRACT

A system for balancing manufacturing orders includes an order adjusting module (201), an order balancing module (202), a yield gathering module (203), and a document updating module (205). The yield gathering module is used to gather production yields. The order balancing module is used to balance manufacturing orders in accordance with daily production yields. The order adjusting module is used to receive manufacturing order adjusting orders from a user. The document updating module is used to update data stored in a database server (121). A related method includes: (a) gathering daily yields from daily production statements and daily stock receipt statements; (b) balancing manufacturing orders in accordance with quantities of manufactured products; (c) deducting data on quantities of materials stored in planning bills of material of corresponding manufacturing orders from data stored in a record of shop floor depot; and (d) updating data stored in a database server.

### BACKGROUND OF THE INVENTION

1. Field of the Invention

The present invention relates to a computer data process system in the manufacturing industry, and especially to a system and method for managing manufacturing orders via distributed computers.

2. Background of the Invention

Globalized economic development has brought tremendous business opportunities to numerous enterprises, and has also brought more pressure to bear on manufacturing enterprises. For example, more and more customized products are being ordered by a wider range of customers, and customers are requiring more rigorous quality standards and more demanding delivery deadlines. Further, an enterprise's manufacturing may be conducted in a number of different countries across the globe, making management of the enterprise a challenging task. A competitive enterprise needs to adopt new technologies, design new products, reduce manufacturing cycles of products, enhance productivity, and reduce costs. Such enterprise should also strengthen manufacturing management, such as supply of materials, product manufacturing, and merchandise distribution. The enterprise should further cooperate with suppliers, dealers, and customers to make the best of their shared and respective resources. By such means, the enterprise can achieve high customer satisfaction, and maintain keen competitiveness.

Manufacturing resource planning (MRPII) systems can assist in advancing an enterprise's competitiveness. For example, P.R. China patent application No. 01118171.0 entitled “System for Manufacturing Management” discloses an information system for manufacturing management. In this system, a network is used to connect a central processing device with a plurality of terminal devices. The central processing device processes data from the terminal devices, and sends management information to the terminal devices to manage manufacturing on a shop floor. The system can help the enterprise manufacture high quality products, enhance productivity, reduce costs of resources, and shorten manufacturing life cycles.

However, changes in a manufacturing schedule can occur at any time and for any of a variety of reasons. For example, a customer may changes its orders, a supplier may change delivery times of materials, and manufacturing machinery may break down or function poorly. The enterprise may not be able to keep to its original fixed production plan. In these circumstances, the above-described information system for manufacturing management is of little value. To maintain enhanced productivity, an enterprise needs to be able to flexibly change production planning according to commercial vicissitudes.

### SUMMARY OF THE INVENTION

Accordingly, an objective of the present invention is to provide a system for balancing manufacturing orders which can timely balance manufacturing orders in accordance with manufactured product quantities.

Another objective of the present invention is to provide a method for balancing manufacturing orders which can timely balance manufacturing orders in accordance with manufactured product quantities.

In order to achieve the first above-mentioned objective, a system for balancing manufacturing orders in accordance with the present invention comprises an order adjusting module, an order balancing module, a yield gathering module and a document updating module. The yield gathering module is used to gather production yields in accordance with data stored in daily production statements and daily stock receipt statements. The order balancing module is used to balance manufacturing orders in accordance with daily production yield gathering by the yield gathering module. The order adjusting module is used to receive manufacturing order adjusting orders from a user. The document updating module is used to update data stored in a master list of manufacturing orders, detailed records of manufacturing orders, and corresponding planning bills of material (BOMs) in accordance with data updating orders generated by the order balancing module and the order adjusting module.

In order to achieve the second above-mentioned objective, a method for balancing manufacturing orders in accordance with the present invention comprises the steps of: (a) gathering daily yields from daily production statements and daily stock receipt statements; (b) balancing manufacturing orders in accordance with quantities of products; (c) deducting data on quantities of materials stored in planning BOMs of corresponding manufacturing orders from data stored in a record of shop floor depot, and updating storage data on the products; and (d) updating data stored in a master list of manufacturing orders, a corresponding detailed record of a manufacturing order, and a corresponding planning BOM.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for balancing manufacturing orders in accordance with a preferred embodiment of the present invention, the system comprising a plurality of client computers, an application server, and a database server;

FIG. 2 is a block diagram of function modules of the application server and the database server, and of communication between the application server and the database server;

FIG. 3 is a flow chart of balancing manufacturing orders in accordance with a preferred embodiment of the present invention; and

FIG. 4 is a flow chart of details of one step of FIG. 3, namely balancing data stored in manufacturing orders.

### DETAILED DESCRIPTION OF PREFERRED EMBODIMENTS OF THE INVENTION

Reference will now be made to the drawings to describe the present invention in detail.

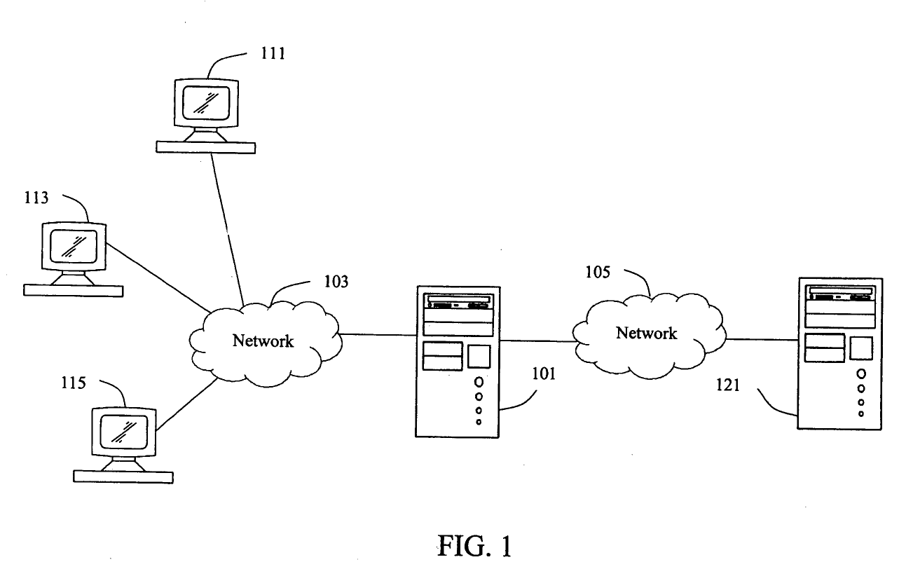

FIG. 1 is a schematic diagram of hardware configuration of a system for balancing manufacturing orders in accordance with the preferred embodiment of the present invention. The system for balancing manufacturing orders comprises a three-layer information system. The three-layer information system comprises a data access layer, a business logic layer, and a presentation layer. The data access layer comprises a database server 121. The business logic layer comprises an application server 101. The presentation layer comprises a plurality of client computers. For the purposes of conveniently illustrating the preferred embodiment of the present invention, three client computers 111, 113, 115 are shown and described hereinafter. Computer communication networks 103, 105 interconnect all the above-mentioned apparatuses.

The application server 101 comprises core and mutable enterprise logic (such as rules, execution, and management) of the system for balancing manufacturing orders. The application server 101 processes input by users at the client computers 111, 113, 115, and returns results of processing to the users. The database server 121 has a database located therein, which stores all structured data on an enterprise. The database server 121 is used for managing processing of the stored data. Such processing includes reading, writing, deleting, modifying, and backup. The client computers 111, 113, 115 have the function of receiving orders input by users, and displaying results of implementation of such orders. The client computers 111, 113, 115 can be simple input/output devices known in the art.

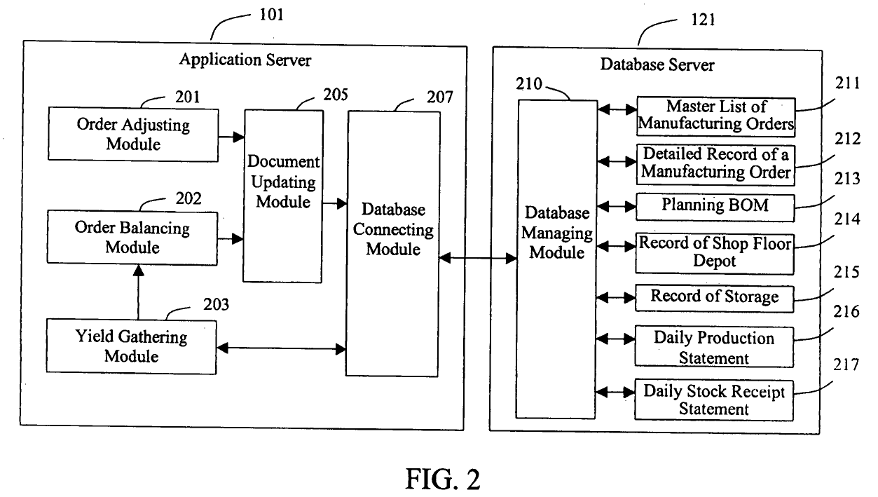

FIG. 2 is a block diagram of function modules of the application server 101 and the database server 121, and of communication between the application server 101 and the database server 121. The application server 101 includes an order adjusting module 201, an order balancing module 202, a yield gathering module 203, a document updating module 205, and a database connecting module 207. The database server 121 includes a database managing module 210, a master list of manufacturing orders 211, a plurality of detailed records of manufacturing orders 212 (only one shown), a plurality of planning BOMs (bills of material) 213 (only one shown), a record of shop floor depot 214, a record of storage 215, a plurality of daily production statements 216 (only one shown), and a plurality of daily stock receipt statements 217 (only one shown). Each manufacturing order corresponds to one detailed record of a manufacturing order 212 and one planning BOM 213. In the preferred embodiment of the present invention, each manufacturing order is an order to a shop floor to manufacture a fixed quantity of designated products within a fixed time.

The master list of manufacturing orders 211 comprises the following data on each manufacturing order: data on an ID of the manufacturing order, a category of the manufacturing order, a code of an enterprise, quantities of products, modes of manufacturing scheduling, and a status of the manufacturing order. Modes of manufacturing scheduling refer to different ways in which the same product or similar products are made. For example, a product may be made by adding on successive components in a particular sequence. The same or a similar product may also be made by adding on the same components successively, but in a different sequence. Each detailed document of a manufacturing order 212 comprises data on an ID of the manufacturing order, quantities of products, scheduled manufacturing output, scheduled manufacturing starting times, stock storage after manufacturing, actual manufacturing starting times, actual manufacturing completion times, a total quantity upon completion of manufacturing, and a quantity of residue stock. Each planning BOM 213 comprises data on an ID of a corresponding manufacturing order, codes of materials, a storage code, and quantities of the materials. Each record of shop floor depot 214 comprises codes of materials, quantities of materials, and IDs of manufacturing orders. The record of storage 215 comprises codes of materials, quantities of materials, and area codes of storages. The daily production statements 216 and the daily stock receipt statements 217 record information on daily yield and stock receipts. The information on daily yield comprises product IDs, quantities, and manufacturing modes of the products.

The yield gathering module 203 is used to gather production yields in accordance with data stored in the daily production statements 216 and the daily stock receipt statements 217. The daily production statements 216 and the daily stock receipt statements 217 respectively store daily production yields and daily stock receipts. The data stored in the daily production statements 216 and the daily stock receipt statements 217 is input by users via the client computers 111, 113, 115 according to actual production yield. The order balancing module 202 is used to balance manufacturing orders in accordance with daily production yield gathering by the yield gathering module 203. The order balancing module 202 generates a temporary record for storing updating information on manufacturing orders. The order adjusting module 201 receives manufacturing order revision instructions from users. The revision instructions include reclaiming a manufacturing order, canceling a manufacturing order, and changing a manufacturing order. The manufacturing order revision instructions are added to the temporary record. The document updating module 205 is used to update data stored in the database server 121 in accordance with information stored in the temporary record via the database connecting module 207 and the database managing module 210.

The database connecting module 207 is used for connecting the application server 101 with the database server 121. The database connecting module 207 controls data communication between applications and source data. Applications of the application server 101 can access data stored in different database management systems (DBMSs) via the database connecting module 207. The database connecting module 207 can be based on open database connectivity (ODBC). The database managing module 210 is used to manage data stored in the database server 121, including data stored in the master list of manufacturing orders 211, the detailed records of manufacturing orders 212 and the planning BOMs 213.

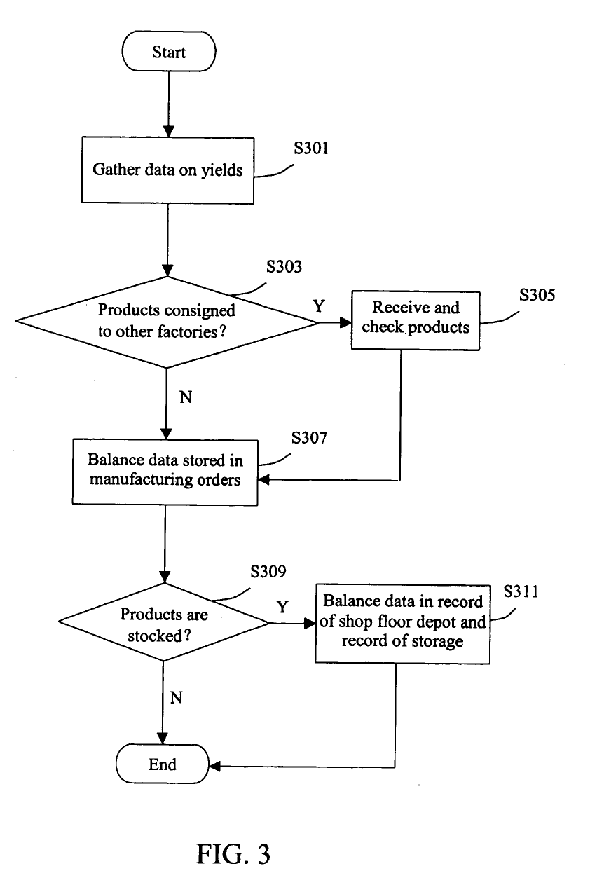

FIG. 3 is a flow chart of a preferred method for balancing manufacturing orders in accordance with the present invention. Firstly, in step S301, the yield gathering module 203 gathers data on daily production yields from the daily production statements 216 and daily stock receipt statements 217 via the database connecting module 207 and the database managing module 210, and sends the data on daily production yields to the order balancing module 202. The daily production yields are also added to the record of shop floor depot 214 or the record of storage 215 when the products are sent to storages.

In step S303, the order balancing module 202 reads information on production yields, and determines whether products are consigned to other factories for manufacturing. If the products are not consigned to other factories, the procedure proceeds directly to step S307 described below. If the products are consigned to other factories, in step S305, the order balancing module 202 further reads data on receiving and checking of the products. Said data is stored in the daily production statements 216 and daily stock receipt statements 217, and is recorded during the procedure of sending the products to the storages. Once said data has been read, the procedure proceeds to step S307. In step S307, the order balancing module 202 balances manufacturing orders in accordance with data on product quantities, and the document updating module 205 updates data stored in the database server 121 via the database connecting module 207 and the database manufacturing module 210. In the balancing procedure, the order balancing module 202 reduces quantities of products stored in the corresponding detailed record of a manufacturing order 212 and the master list of manufacturing orders 211 in accordance with the data on receiving products. If the quantities of the data on receiving products exceeded the quantities on the manufacturing order, the manufacture order is deleted from the master list of manufacturing orders 211, the quantity of residue in the detailed record of a manufacturing order 212 is reduced to zero, the quantities of the data on receiving products are reduced by corresponding amounts, and the order balancing module 202 balances other manufacturing orders according to the residue quantities of products.

In step S309, the order balancing module 202 determines whether the products are stocked or slated to be stocked in accordance with scheduled manufacturing output information stored in a corresponding detailed record of a manufacturing order 212. “Stocked or slated to be stocked” refers to adding data on the products to the corresponding record of storage 215 (as opposed to sending the physical products to storages). If the products are not stocked or slated to be stocked, the procedure is ended. If the products are stocked or slated to be stocked, in step S311, the order balancing module 202 deducts data on quantities of the materials stored in the planning BOMs of corresponding manufacturing orders from data stored in the record of shop floor depot 214, and updates storage data on the products in the corresponding record of storage 215. Thereupon the procedure is ended.

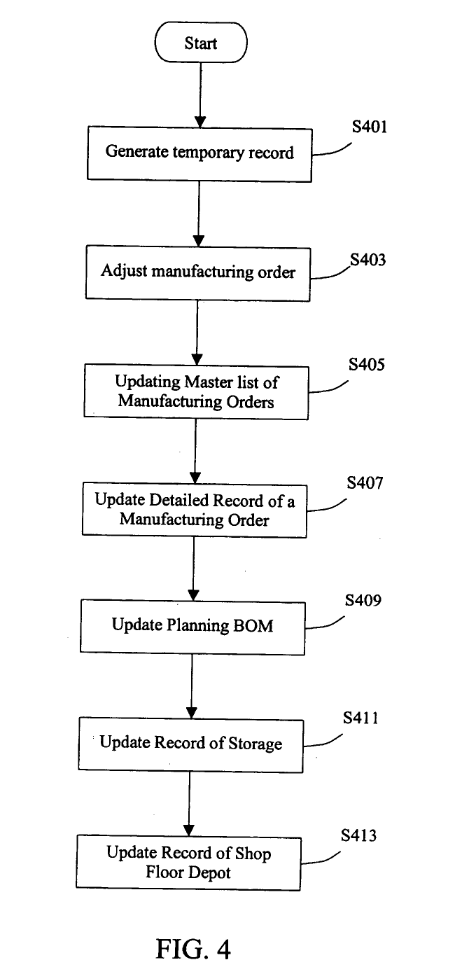

FIG. 4 is a flow chart of details of step S307 of FIG. 3, namely balancing data stored in manufacturing orders. In step S401, the order balancing module 202 generates a temporary record for storing updating information on manufacturing orders. In step S403, the order adjusting module 201 receives a manufacturing order revision instruction from a user via any of the client computers 111, 113, 115. For example, the user can update modes of manufacturing scheduling of a manufacturing order. The manufacturing order revision instruction and the duly balanced manufacturing order are both added to the temporary record.

In step S405, the document updating module 205 updates statuses of the corresponding manufacturing orders in the master list of manufacturing orders 211 in accordance with the temporary record generated by the order balancing module 202. If the products are manufactured, the status of the corresponding manufacturing orders are changed to finished. If the quantities of the products are not enough to balance any manufacturing order, in step S407, the document updating module 205 updates data stored in a corresponding detailed record of a manufacturing order 212. In steps S409, S411 and S413, the document updating module 205 updates the planning BOM 213, the record of storage 215, and the record of shop floor depot 214 in that order.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for balancing manufacturing orders, the system comprising an order adjusting module, an order balancing module, a yield gathering module and a document updating module, wherein:
the yield gathering module is used to gather production yields in accordance with data stored in daily production statements and daily stock receipt statements;
the order balancing module is used to balance manufacturing orders in accordance with daily production yield gathering by the yield gathering module;
the order adjusting module is used to receive manufacturing order adjusting instructions from a user; and
the document updating module is used to update data stored in a master list of manufacturing orders, detailed records of manufacturing orders, and corresponding planning bills of material (BOMs) in accordance with data updating orders generated by the order balancing module and the order adjusting module.

2. The system as claimed in claim 1, wherein the order adjusting module, the order balancing module, the yield gathering module and the document updating module are comprised in an application server.

3. The system as claimed in claim 1, further comprising a database connecting module which connects the order adjusting module, the order balancing module, the yield gathering module and the document updating module with the master list of manufacturing orders, the detailed records of manufacturing orders and the planning BOMs for data interchange therebetween.

4. The system as claimed in claim 1, wherein the master list of manufacturing orders, the detailed records of manufacturing orders and the planning BOMs are comprised in a database server with a database managing module.

5. The system as claimed in claim 1, wherein the order balancing module generates a temporary record for recording data on changing of manufacturing orders.

6. The system as claimed in claim 5, wherein the document updating module updates data stored in the master list of manufacturing orders, the detailed records of manufacturing orders, and the planning BOMs in accordance with data stored in the temporary record.

7. A method for balancing manufacturing orders, the method comprising the steps of:
gathering daily yields from daily production statements and daily stock receipt statements;
balancing manufacturing orders in accordance with quantities of products;
deducting data on quantities of materials stored in planning BOMs of corresponding manufacturing orders from data stored in a record of shop floor depot, and updating storage data on the products; and
updating data stored in a master list of manufacturing orders, a corresponding detailed record of a manufacturing order, and a corresponding planning BOM.

8. The method as claimed in claim 7, further comprising the step of adjusting manufacturing orders.

9. A system for balancing manufacturing orders, the system comprising:
means for daily yields from daily production statements and daily stock receipt statements;
means for balancing manufacturing orders in accordance with quantities of made products;
means for deducting data quantities of materials stored in planning BOMs of corresponding manufacturing orders from data stored in a record of shop floor depot, and updating storage data on the products; and
means for updating data stored in a master list of manufacturing orders, a corresponding detailed record of a manufacturing order, and a corresponding planning BOM.
